(19) United States
(12) Patent Application Publication
(10) Pub. No.: US 2026/0223250 A1
(43) Pub. Date: Jul. 30, 2026

(54) MULTICAST AND BROADCAST SERVICES BROADCASTING IN DISAGGREGATED AND SHARED RADIO ACCESS NETWORK DEPLOYMENT

(71) Applicant: Nokia Technologies Oy, Espoo (FI)

(72) Inventors: Bighnaraj PANIGRAHI, Bangalore (IN); Philippe GODIN, Massy (FR); Ugur Baran ELMALI, Munich (DE); Esa Mikael MALKAMÄKI, Espoo (FI)

(21) Appl. No.: 19/147,433

(22) PCT Filed: Jan. 12, 2024
(86) PCT No.: PCT/IB2024/050341

§ 371 Date: Jul. 11, 2025

(30) Foreign Application Priority Data
Feb. 1, 2023 (IN) 202341006508

(51) Int. Cl. H04W 76/40; H04W 28/06; H04W 84/04

(52) U.S. Cl. CPC H04W 76/40; H04W 28/06; H04W 84/042

(57) ABSTRACT

A method may include receiving a first broadcast setup request message. The method may also include receiving a second broadcast setup request message from a second centralized unit network element, managed by another one of the sharing public land mobile networks. The first and second broadcast session setup request messages may correspond to a same broadcast service shared by two of the public land mobile networks sharing the distributed radio access node. The first configuration and the second configuration may be different. A determination may be made as to whether to send a feedback message to the second centralized unit network, and whether the second centralized unit network element can accept at least one of the configurations sent in the feedback message. A final response message is transmitted to the second centralized unit network element indicating a successful or failed setup.

### RELATED APPLICATION

This application claims priority to IN provisional Application No. 20/2341006508 filed Feb. 1, 2023, which is incorporated herein by reference in its entirety.

### FIELD

Some example embodiments may generally relate to mobile or wireless telecommunication systems, such as Long Term Evolution (LTE) or fifth generation (5G) new radio (NR) access technology, or 5G beyond, or other communications systems. For example, certain example embodiments may relate to apparatuses, systems, and/or methods for multicast and broadcast services (MBS) broadcasting in disaggregated and shared radio access network (RAN) deployment.

### BACKGROUND

Examples of mobile or wireless telecommunication systems may include the Universal Mobile Telecommunications System (UMTS) Terrestrial Radio Access Network (UTRAN), LTE Evolved UTRAN (E-UTRAN), LTE-Advanced (LTE-A), MulteFire, LTE-A Pro, and/or fifth generation (5G) radio access technology or NR access technology. 5G wireless systems refer to the next generation (NG) of radio systems and network architecture. 5G network technology is mostly based on new radio (NR) technology, but the 5G (or NG) network can also build on E-UTRAN radio. It is estimated that NR may provide bitrates on the order of 10-20 Gbit/s or higher, and may support at least enhanced mobile broadband (eMBB) and ultra-reliable low-latency communication (URLLC) as well as massive machine-type communication (mMTC). NR is expected to deliver extreme broadband and ultra-robust, low-latency connectivity and massive networking to support the IoT.

### SUMMARY

Some example embodiments may be directed to a method. The method may include receiving in a distributed radio access node shared by two or more public land mobile networks, a first broadcast setup request message from a first centralized unit network element, managed by one of the sharing public land mobile networks. According to certain example embodiments, the first broadcast setup request message includes a first configuration of the first centralized unit network element. The method may also include receiving in the distributed radio access node a second broadcast setup request message from a second centralized unit network element, managed by another one of the sharing public land mobile networks. According to certain example embodiments, the second broadcast setup request message includes a second configuration of the second centralized unit network element. The method may further include determining that the first and second broadcast session setup request messages correspond to a same broadcast service shared by two of the public land mobile networks sharing the shared distributed radio access. In addition, the method may include determining that the first configuration and the second configuration are different. Further, the method may include determining whether to send a feedback message to the second centralized unit network element including a list of configurations including at least the first configuration or a current operating configuration. The method also includes determining from a response of the second centralized unit network element to the feedback message whether the second centralized unit network element can accept at least one of the configurations sent in the feedback message. The method further includes transmitting a final response message to the second centralized unit network element indicating a successful or failed setup based on the determination from the response of the second centralized unit network element to the feedback message.

Other example embodiments may be directed to an apparatus. The apparatus may include at least one processor and at least one memory including computer program code. The at least one memory and computer program code may also be configured to, with the at least one processor, cause the apparatus at least to receive in a distributed radio access node shared by two or more public land mobile networks, a first broadcast setup request message from a first centralized unit network element, managed by one of the sharing public land mobile networks. According to certain example embodiments, the first broadcast setup request message may include a first configuration of the first centralized unit network element. The apparatus may also be caused to receive in the distributed radio access node a second broadcast setup request message from a second centralized unit network element, managed by another one of the sharing public land mobile networks. According to certain example embodiments, the second broadcast setup request message may include a second configuration of the second centralized unit network element. The apparatus may further be caused to determine that the first and second broadcast session setup request messages correspond to a same broadcast service shared by two of the public land mobile networks sharing the distributed radio access node. In addition, the apparatus may be caused to determine that the first configuration and the second configuration are different. Further, the apparatus may be caused to determine whether to send a feedback message to the second centralized unit network element including a list of configurations including at least the first configuration or a current operating configuration. The apparatus may also be caused to determine from a response of the second centralized unit network element to the feedback message whether the second centralized unit network element can accept at least one of the configurations sent in the feedback message. The apparatus may further be caused to transmit a final response message to the second centralized unit network element indicating a successful or failed setup based on the determination from the response of the second centralized unit network element to the feedback message.

Other example embodiments may be directed to an apparatus. The apparatus may include means for receiving in a distributed radio access node shared by two or more public land mobile networks, a first broadcast setup request message from a first centralized unit network element, managed by one of the sharing public land mobile networks. According to certain example embodiments, the first broadcast setup request message may include a first configuration of the first centralized unit network element. The apparatus may also include means for receiving in the distributed radio access node a second broadcast setup request message from a second centralized unit network element, managed by another one of the sharing public land mobile networks. According to certain example embodiments, the second broadcast setup request message includes a second configuration of the second centralized unit network element. The apparatus may further include means for determining that the first and second broadcast session setup request messages correspond to a same broadcast service shared by two of the public land mobile networks sharing the distributed radio access node. In addition, the apparatus may include means for determining that the first configuration and the second configuration are different. Further, the apparatus may include means for determining whether to send a feedback message to the second centralized unit network element including a list of configurations including at least the first configuration or a current operating configuration. The apparatus may also include means for determining from a response of the second centralized unit network element to the feedback message whether the second centralized unit network element can accept at least one of the configurations sent in the feedback message. The apparatus may further include means for transmitting a final response message to the second centralized unit network element indicating a successful or failed setup based on the determination from the response of the second centralized unit network element to the feedback message.

In accordance with other example embodiments, a non-transitory computer readable medium may be encoded with instructions that may, when executed in hardware, perform a method. The method may include receiving in a distributed radio access node shared by two or more public land mobile networks, a first broadcast setup request message from a first centralized unit network element, managed by one of the sharing public land mobile networks. According to certain example embodiments, the first broadcast setup request message includes a first configuration of the first centralized unit network element. The method may also include receiving in the distributed radio access node a second broadcast setup request message from a second centralized unit network element, managed by another one of the sharing public land mobile networks. According to certain example embodiments, the second broadcast setup request message includes a second configuration of the second centralized unit network element. The method may further include determining that the first and second broadcast session setup request messages correspond to a same broadcast service shared by two of the public land mobile networks sharing the shared distributed radio access. In addition, the method may include determining that the first configuration and the second configuration are different. Further, the method may include determining whether to send a feedback message to the second centralized unit network element including a list of configurations including at least the first configuration or a current operating configuration. The method also includes determining from a response of the second centralized unit network element to the feedback message whether the second centralized unit network element can accept at least one of the configurations sent in the feedback message. The method further includes transmitting a final response message to the second centralized unit network element indicating a successful or failed setup based on the determination from the response of the second centralized unit network element to the feedback message.

Other example embodiments may be directed to a computer program product that performs a method. The method may include receiving in a distributed radio access node shared by two or more public land mobile networks, a first broadcast setup request message from a first centralized unit network element, managed by one of the sharing public land mobile networks. According to certain example embodiments, the first broadcast setup request message includes a first configuration of the first centralized unit network element. The method may also include receiving in the distributed radio access node a second broadcast setup request message from a second centralized unit network element, managed by another one of the sharing public land mobile networks. According to certain example embodiments, the second broadcast setup request message includes a second configuration of the second centralized unit network element. The method may further include determining that the first and second broadcast session setup request messages correspond to a same broadcast service shared by two of the public land mobile networks sharing the shared distributed radio access. In addition, the method may include determining that the first configuration and the second configuration are different. Further, the method may include determining whether to send a feedback message to the second centralized unit network element including a list of configurations including at least the first configuration or a current operating configuration. The method also includes determining from a response of the second centralized unit network element to the feedback message whether the second centralized unit network element can accept at least one of the configurations sent in the feedback message. The method further includes transmitting a final response message to the second centralized unit network element indicating a successful or failed setup based on the determination from the response of the second centralized unit network element to the feedback message.

Other example embodiments may be directed to an apparatus that may include circuitry configured to receive in a distributed radio access node shared by two or more public land mobile networks, a first broadcast setup request message from a first centralized unit network element, managed by one of the sharing public land mobile networks. According to certain example embodiments, the first broadcast setup request message may include a first configuration of the first centralized unit network element. The apparatus may also include circuitry configured to receive in the distributed radio access node a second broadcast setup request message from a second centralized unit network element, managed by another one of the sharing public land mobile networks. According to certain example embodiments, the second broadcast setup request message may include a second configuration of the second centralized unit network element. The apparatus may further include circuitry configured to determine that the first and second broadcast session setup request messages correspond to a same broadcast service shared by two of the public land mobile networks sharing the distributed radio access node. In addition, the apparatus may include circuitry configured to determine that the first configuration and the second configuration are different. Further, the apparatus may include circuitry configured to determine whether to send a feedback message to the second centralized unit network element including a list of configurations including at least the first configuration or a current operating configuration. The apparatus may also include circuitry configured to determine from a response of the second centralized unit network element to the feedback message whether the second centralized unit network element can accept at least one of the configurations sent in the feedback message. The apparatus may further include circuitry configured to transmit a final response message to the second centralized unit network element indicating a successful or failed setup based on the determination from the response of the second centralized unit network element to the feedback message.

Certain example embodiments may be directed to a method. The method may include transmitting to a distributed radio access node shared by two or more public land mobile networks, a first broadcast setup request message corresponding to a broadcast service. According to certain example embodiments, the first broadcast setup request message may include a first configuration of a first centralized unit network element managed by one of the sharing public land mobile networks. The method may also include transmitting to the distributed radio access node a second broadcast setup request message corresponding to the broadcast service. According to certain example embodiments, the second broadcast setup request message may include a second configuration of a second centralized unit network element managed by another one of the sharing public land mobile networks. The method may further include receiving a feedback message at the second centralized unit network element from the distributed radio access node including a list of configurations including at least the first configuration or a current operating configuration. In addition, the method may include transmitting, at the second centralized unit network element, in response to the feedback message, an indication to the distributed radio access node whether at least one of the configurations sent in the feedback message can be accepted or else proposing another configuration. Further, the method may include receiving, at the second centralized unit network element, a final response message from the distributed radio access node indicating a successful or failed setup based on the response to the feedback message.

Other example embodiments may be directed to an apparatus. The apparatus may include at least one processor and at least one memory including computer program code. The at least one memory and computer program code may be configured to, with the at least one processor, cause the apparatus at least to transmit to a distributed radio access node shared by two or more public land mobile networks, a first broadcast setup request message corresponding to a broadcast service. According to certain example embodiments, the first broadcast setup request message may include a first configuration of a first centralized unit network element managed by one of the sharing public land mobile networks. The apparatus may also be caused to transmit to the distributed radio access node a second broadcast setup request message corresponding to the broadcast service. According to certain example embodiments, the second broadcast setup request message may include a second configuration of a second centralized unit network element managed by another one of the sharing public land mobile networks. The apparatus may further be caused to receive a feedback message at the second centralized unit network element from the distributed radio access node comprising a list of configurations comprising at least the first configuration or a current operating configuration. In addition, the apparatus may be caused to transmit, at the second centralized unit network element, in response to the feedback message, an indication to the distributed radio access node whether at least one of the configurations sent in the feedback message can be accepted or else proposing another configuration. Further, the apparatus is caused to receive, at the second centralized unit network element, a final response message from the distributed radio access node indicating a successful or failed setup based on the response to the feedback message.

Other example embodiments may be directed to an apparatus. The apparatus may include means for transmitting to a distributed radio access node shared by two or more public land mobile networks, a first broadcast setup request message corresponding to a broadcast service. According to certain example embodiments, the first broadcast setup request message may include a first configuration of a first centralized unit network element managed by one of the sharing public land mobile networks. The apparatus may also include means for transmitting to the distributed radio access node a second broadcast setup request message corresponding to the broadcast service. According to certain example embodiments, the second broadcast setup request message may include a second configuration of a second centralized unit network element managed by another one of the sharing public land mobile networks. The apparatus may further include means for receiving a feedback message at the second centralized unit network element from the distributed radio access node comprising a list of configurations comprising at least the first configuration or a current operating configuration. In addition, the apparatus may include means for transmitting, at the second centralized unit network element, in response to the feedback message, an indication to the distributed radio access node whether at least one of the configurations sent in the feedback message can be accepted or else proposing another configuration. In addition, the apparatus may include means for receiving, at the second centralized unit network element, a final response message from the distributed radio access node indicating a successful or failed setup based on the response to the feedback message.

In accordance with other example embodiments, a non-transitory computer readable medium may be encoded with instructions that may, when executed in hardware, perform a method. The method may include transmitting to a distributed radio access node shared by two or more public land mobile networks, a first broadcast setup request message corresponding to a broadcast service. According to certain example embodiments, the first broadcast setup request message may include a first configuration of a first centralized unit network element managed by one of the sharing public land mobile networks. The method may also include transmitting to the distributed radio access node a second broadcast setup request message corresponding to the broadcast service. According to certain example embodiments, the second broadcast setup request message may include a second configuration of a second centralized unit network element managed by another one of the sharing public land mobile networks. The method may further include receiving a feedback message at the second centralized unit network element from the distributed radio access node comprising a list of configurations comprising at least the first configuration or a current operating configuration. In addition, the method may include transmitting, at the second centralized unit network element, in response to the feedback message, an indication to the distributed radio access node whether at least one of the configurations sent in the feedback message can be accepted or else proposing another configuration. Further, the method may include receiving, at the second centralized unit network element, a final response message from the distributed radio access node indicating a successful or failed setup based on the response to the feedback message.

Other example embodiments may be directed to a computer program product that performs a method. The method may include transmitting to a distributed radio access node shared by two or more public land mobile networks, a first broadcast setup request message corresponding to a broadcast service. According to certain example embodiments, the first broadcast setup request message may include a first configuration of a first centralized unit network element managed by one of the sharing public land mobile networks. The method may also include transmitting to the distributed radio access node a second broadcast setup request message corresponding to the broadcast service. According to certain example embodiments, the second broadcast setup request message may include a second configuration of a second centralized unit network element managed by another one of the sharing public land mobile networks. The method may further include receiving a feedback message at the second centralized unit network element from the distributed radio access node comprising a list of configurations comprising at least the first configuration or a current operating configuration. In addition, the method may include transmitting, at the second centralized unit network element, in response to the feedback message, an indication to the distributed radio access node whether at least one of the configurations sent in the feedback message can be accepted or else proposing another configuration. Further, the method may include receiving, at the second centralized unit network element, a final response message from the distributed radio access node indicating a successful or failed setup based on the response to the feedback message.

Other example embodiments may be directed to an apparatus that may include circuitry configured to transmit to a distributed radio access node shared by two or more public land mobile networks, a first broadcast setup request message corresponding to a broadcast service. According to certain example embodiments, the first broadcast setup request message may include a first configuration of a first centralized unit network element managed by one of the sharing public land mobile networks. The apparatus may also include circuitry configured to transmit to the distributed radio access node a second broadcast setup request message corresponding to the broadcast service. According to certain example embodiments, the second broadcast setup request message comprises a second configuration of a second centralized unit network element managed by another one of the sharing public land mobile networks. The apparatus may further include circuitry configured to receive a feedback message at the second centralized unit network element from the distributed radio access node comprising a list of configurations comprising at least the first configuration or a current operating configuration. In addition, the apparatus may include circuitry configured to transmit, at the second centralized unit network element, in response to the feedback message, an indication to the distributed radio access node whether at least one of the configurations sent in the feedback message can be accepted or else proposing another configuration. Further, the apparatus may include circuitry configured to receive, at the centralized unit network element, a final response message from the shared distributed radio access node indicating a successful or failed setup based on the response to the feedback message.

### BRIEF DESCRIPTION OF THE DRAWINGS

For proper understanding of example embodiments, reference should be made to the accompanying drawings, wherein:

FIG. 1 illustrates an example deployment scenario.

FIG. 2 illustrates an example broadcast context setup procedure.

FIG. 3 illustrates an example signal flow diagram according to certain example embodiments.

FIG. 4 illustrates another example signal flow diagram, according to certain example embodiments.

FIG. 5 illustrates another example signal flow diagram, according to certain example embodiments.

FIG. 6 illustrates a further example signal flow diagram, according to certain example embodiments.

FIG. 7 illustrates an example flow diagram of a method, according to certain example embodiments.

FIG. 8 illustrates an example flow diagram of another method, according to certain example embodiments.

FIG. 9 illustrates a set of apparatuses, according to certain example embodiments.

### DETAILED DESCRIPTION

It will be readily understood that the components of certain example embodiments, as generally described and illustrated in the figures herein, may be arranged and designed in a wide variety of different configurations. The following is a detailed description of some example embodiments of systems, methods, apparatuses, and computer program products for (Multicast and Broadcast Service) MBS broadcasting in disaggregated and shared RAN deployment. For instance, certain example embodiments may be directed to MBS broadcasting in disaggregated and shared RAN deployment.

The features, structures, or characteristics of example embodiments described throughout this specification may be combined in any suitable manner in one or more example embodiments. For example, the usage of the phrases “certain embodiments,” “an example embodiment,” “some embodiments,” or other similar language, throughout this specification refers to the fact that a particular feature, structure, or characteristic described in connection with an embodiment may be included in at least one embodiment. Thus, appearances of the phrases “in certain embodiments,” “an example embodiment,” “in some embodiments,” “in other embodiments,” or other similar language, throughout this specification do not necessarily refer to the same group of embodiments, and the described features, structures, or characteristics may be combined in any suitable manner in one or more example embodiments. Further, the terms “cell”, “node”, “gNB”, “network” or other similar language throughout this specification may be used interchangeably. Additionally, the terms “distributed unit (DU)” and “gNB-DU”, and “centralized unit (CU)” and “gNB-CU” throughout this specification may be used interchangeably.

As used herein, “at least one of the following: <a list of two or more elements>” and “at least one of <a list of two or more elements>” and similar wording, where the list of two or more elements are joined by “and” or “or,” mean at least any one of the elements, or at least any two or more of the elements, or at least all the elements.

The technical specifications of 3rd Generation Partnership Project (3GPP) describe enhancements in relation to identifying and evaluating 5GS architecture to provide MBS. Various solutions have been provided including, for example, a common temporary mobile group identity (TMGI) may be provided for different public land mobile networks (PLMNs) (e.g., PLMN-A and PLMN-B may use the same common TMGI for the same service). This solution may be coordinated via an application function (AF). In another solution, each PLMN may create a separate native TMGI for the same service. However, additional information may be sent to the NG-RAN node such that a shared NG-RAN node understands that both the TMGIs refer to the same service, and transmits data only once in a radio interface. According to another solution, shared NG-RAN nodes may already be configured with the PLMN-IDs of each of the sharing partners, and may be configured with the specific respective service-ID (e.g., 6-digit numbers) of the TMGIs of two PLMNs that correspond to the same content or range of service-IDs.

In the first solution, the 5G core network (CN) may send a common identifier (e.g., source-specific multicast (SSM) address) along with the TMGI separately created at each 5G CN (of each PLMN) for the same service. When the NG-RAN node receives a request for the creation of the broadcast session coming from different core networks via different TMGIs along with a common identifier SSM address, the NG-RAN node may understand that those different TMGIs belong to the same service. Thus, the RAN node may transmit the same data only once in the radio interface using the same G-radio network temporary identifier (G-RNTI). Further, user equipments (UEs) of the sharing PLMNs (e.g., UEs belonging to PLMN A, PLMN B, and PLMN C that shares a common NG-RAN node) may receive the data (and corresponding physical downlink control channel (PDCCH) for the same service only once that is scrambled via the same G-RNTI.

In the second solution described above, the shared NG-RAN node may be configured with the information such that TMGIs may belong to the same broadcast session created by different 5G CNs. By doing so, the NG-RAN may understand that those TMGIs coming from different PLMNs belong to the same service, and therefore may transmit the same data only once in the radio interface.

There may be various deployment options for aggregated and disaggregated NG-RAN types in MBS broadcasts. For instance, some deployment options may include, but not be limited to, aggregated gNB, disaggregated gNB, and only some cells within the gNB are shared, etc. For disaggregated gNB, both centralized unit (CU) and distributed unit (DU) may be shared. Additionally, for disaggregated gNB, there may be only DU-shared and CU-not shared options. The solutions agreed upon may have a direct impact on the procedures and functions of the specific type of deployment under consideration.

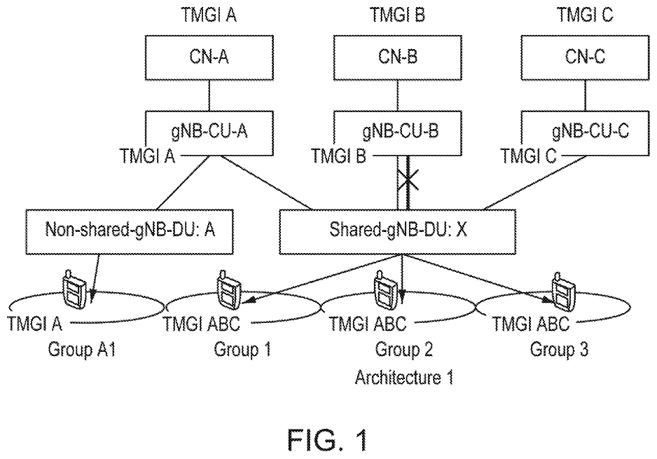

For the deployment where only DU is shared among multiple PLMNs but CUs are different (not shared), it may be assumed that the same MBS broadcast service may be created by multiple CNs. Assuming first solution (different native TMGIs per PLMN), each CN may send separate broadcast setup request towards the shared gNB-DU. FIG. 1 illustrates an example deployment scenario. In the example of FIG. 1, in order to configure the shared radio resource, the gNB-DU may need to know that different TMGIs belong to the same MBS session. The gNB-DU may then assign the same radio resource for the different TMGIs (e.g., discontinuous reception (DRX) configuration for different TMGIs may be configured with the same value and also transmit the data only once). The deployment illustrated in FIG. 1 may be achieved by the CUs forwarding the same common information (i.e., SSM address) to the DU for each TMGI.

A decision may be made on whether there may be more than one next generation-unit (NG-U) tunnel to each CN, and whether there may be multiple F1-U tunnels between different non-shared CUs and the shared DU. It may be possible that in some scenarios, one or more CUs may already communicate the same service to another non-shared DU and, thus, an F1-U tunnel may have already been created with them, along with an NG-U established with the CN.

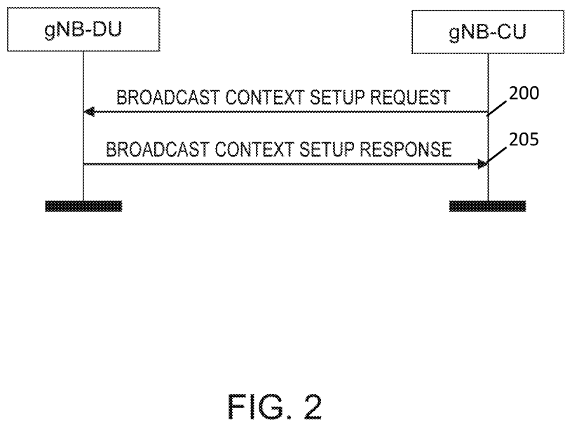

FIG. 2 illustrates an example broadcast context setup procedure. For instance, FIG. 2 illustrates a disaggregated architecture setup where the gNB-CU may, at 200, initiate a setup procedure by sending a BROADCAST CONTEXT SETUP REQUEST message to the gNB-DU. The broadcast context setup request message may be sent to the gNB-DU after the gNB-CU receives a broadcast setup request for a MBS service from the CN. If the gNB-DU succeeds to establish the broadcast context, it may, at 205, reply to the gNB-CU with a BROADCAST CONTEXT SETUP RESPONSE.

In a “non-shared CU and shared DU” type of deployment, a shared gNB-DU may receive from a non-shared CU, gNB-CU-A a broadcast context setup request from a 5G CN, CN-A, with TMGI-A, and other required configurations (e.g., multicast radio bearer (MRB), packet data convergence protocol (PDCP) configuration, etc.) that are created by the gNB-CU-A. The shared gNB-DU may configure the information to broadcast to the UEs. Additionally, a short duration later or at the same time, the shared gNB-DU may receive another broadcast setup request for the same MBS broadcast service (e.g., different TMGI but with identification assistance for first solution) from another non-shared CU, gNB-CU-B of another 5G CN, CN-B with a different configuration. The gNB-CU-B of CN-B may be unaware of the configuration that was already made for the same service for CN-A (by gNB-CU-A).

As the configurations required by different non-shared gNB-CUs may be different, shared gNB-DU may not be able to utilize the shared NG-RAN optimization. That is, the shared gNB-DU may not be able to transmit only one unified configuration and data over the air that are to be received by UEs in different sharing PLMNs, which would lead to multiple redundant broadcast physical downlink control channel (PDCCH)/physical downlink shared channels (PDSCHs) (MBS data). Additionally, this may lead to more severe resource wastage when a higher number of PLMNs/CNs share one common NG-RAN. Thus, certain example embodiments described herein may provide means of coordination between the shared gNB-DU and non-shared gNB-CUs so that the desired MBS RAN sharing feature may be applied to this deployment scenario.

As described herein, certain example embodiments may relate to a shared gNB-DU and multiple non-sharing gNB-CUs to coordinate and optimize the MBS specific radio resources in light of the RAN sharing objective of Rel-18 in the 3GPP TR 23.700-47. For instance, in some example embodiments, after the shared gNB-DU receives a MBS broadcast context setup request from gNB-CU-A along with the TMGI-A (native TMGI+IP SSM for identification) along with other configuration details (e.g., MRB configuration, PDCP SN length, robust header compression (ROHC) parameters, t_reordering, etc.), the shared gNB-DU may configure system information block 20 (SIB20) and multicast control channel (MCCH) using the information and may broadcast with a G-RNTI (for UEs of PLMN A). When the shared gNB-DU receives another subsequent broadcast context setup request from, for example, gNB-CU-B, the shared gNB-DU may have several options for proceeding.

For instance, in some example embodiments, if the shared gNB-DU receives from gNB-CU-B a broadcast context setup request message with CU-B configuration that is compatible or the same as CU-A's, the shared gNB-DU may reply with a broadcast context setup response message to gNB-CU-B, indicating a successful setup. On the other hand, if the CU-B configuration is different than the CU-A's configuration, the shared gNB-DU may transmit an F1 broadcast context setup failure message. Additionally, the shared gNB-DU may include an Available MRB configuration information element (IE) (including all configurations sent for this service by CU-A) containing a CU-A configuration. In other example embodiments, the gNB-CU B may attempt a subsequent F1AP broadcast setup request including CU-A configuration, if desired.

According to another example embodiment, a new class 1 F1 application protocol (F1AP) MRB configuration update procedure may be introduced. Upon an F1AP broadcast context request, the shared gNB-DU may trigger the F1AP MRB configuration update procedure towards the gNB-CU-B. In some example embodiments, the F1AP MRB configuration update procedure may include, in the FIAP MRB configuration an update request message, the CU-A's configuration details. If gNB-CU-B can accept the CU-A's configuration, the gNB-CU-B may reply successfully with an FIAP MRB configuration update response message. Additionally, upon receiving the FIAP MRB configuration update response message, the shared gNB-DU may reply with a broadcast context setup response message which may include the CU-A configuration.

In certain example embodiments, a new class 1 FIAP MRB configuration update procedure may be provided. In some example embodiments, upon receiving the F1AP broadcast context setup request, the shared gNB-DU may trigger the F1AP MRB configuration update procedure towards the gNB-CU-B. The FIAP MRB configuration update procedure may include, in the FIAP MRB configuration update request message, the CU-A configuration. If the gNB-CU-B does not accept shared gNB-DU's proposal to update/change its configuration into gNB-CU-A's configuration, the gNB-CU-B may reply with an FIAP MRB configuration failure message towards the shared gNB-DU. Upon receiving the FIAP MRB configuration update failure message from the shared gNB-CU-B, the gNB-DU may use both the configurations separately and, thus, two different data transmissions (i.e., the shared gNB-DU may reply to the gNB-CU-B with a broadcast setup response message including the originally requested CU-B configuration). This means that the MBS broadcast data may be broadcast two times for the two different TMGIs.

Alternatively, in other example embodiments, upon receiving the FIAP MRB configuration update failure message from the gNB-CU-B, the shared gNB-DU may proceed by continuing a single configuration that may be transparent to gNB-CUs. For instance, the shared gNB-DU may reply with the broadcast setup failure message to the originally requested CU-B configuration in the broadcast setup request message. This means that the shared gNB-DU may continue the broadcast with only the configuration of CU-A. In certain example embodiments, whenever the shared gNB-DU sends a successful broadcast setup response to the gNB-CU control plane, the shared gNB-DU may indicate whether it requests the F1-U tunnel setup with the corresponding gNB-CU user plane by including a new indication (i.e., “ignore DU DL tunnel endpoint identifier (TEID)”) when the shared gNB-DU does not request the setup.

According to other example embodiments, in the broadcast context setup request, the gNB-CU may also newly send its DU non-sharing status parameter to the shared gNB-DU about whether the gNB-CU already provides the service to one or more non-shared gNB-DUs. The receiving shared gNB-DU may take this new parameter into account in the determination of which F1-U tunnel to be setup (i.e., determine the setting of the new “ignore DU DL TEID”). For instance, in some example embodiments, setting up the F1-U tunnel with one particular gNB-CU UP may be preferred by the shared gNB-DU when receiving the parameter indicating that the gNB-CU already provides the service to one or more non-shared DUs. This may be because the NG-U interface was already established between this gNB-CU and its CN to provide the service to those non-shared gNB-DUs.

In certain example embodiments, the shared gNB-DU may receive the first broadcast context from any one of the gNB-CUs, and share the configuration details immediately with all connected gNB-CUs (without waiting for their individual requests). In this example embodiment, if the shared gNB-DU receives different configurations that are incompatible with each other from different gNB-CUs, the shared gNB-DU may not enable MBS RAN sharing optimizations. Instead, the shared gNB-DU may handle the service to UEs in different PLMNs as if they are different services coming from different PLMNs.

According to some example embodiments, if a pre-configuration option is used to identify an MBS shared service across PLMNs (i.e., identification by service ID or service ID range), then all the gNB-CUs may be pre-configured with the TMGI mappings in addition to the shared gNB-DU. According to other example embodiments, if the “association ID” is used to identify MBS shared service across PLMNs, then this association ID may also be shared by receiving shared gNB-DU towards all gNB-CUs immediately as well together with the configuration details.

In certain example embodiments, the shared gNB-DU may receive first broadcast context set up request, and wait until it receives subsequent broadcast contest setup requests from other gNB-CUs (that share the same gNB-DU). Additionally, the shared gNB-DU may then select one (e.g., anyone) of the configurations randomly and updates the same configuration with the remaining gNB-CUs.

According to certain example embodiments, the operation and maintenance (O&M) may configure gNB-CUs with a set of configurations for TMGI enabling identification of the same broadcast service (i.e., for broadcast session sharing the same broadcast service). This may mean that the O&M may pre-configure some configurations to each non-shared gNB-CUs with a shared gNB-DU within the service area of the broadcast session. For example, the O&M platform may configure a rule for quality of service (QOS) flow to MRB mapping. For example, all QoS flows of a particular broadcast service may be mapped to the same MRB or each one mapped to a different MRB. This may ensure the same MRB mapping coming from different non-shared gNB-CUs coming to the shared gNB-DU. In other example embodiments, the O&M platform may also configure PDCP configurations including reordering timer and PDCP SN length. Additionally, the O&M platform may configure ROHC configurations.

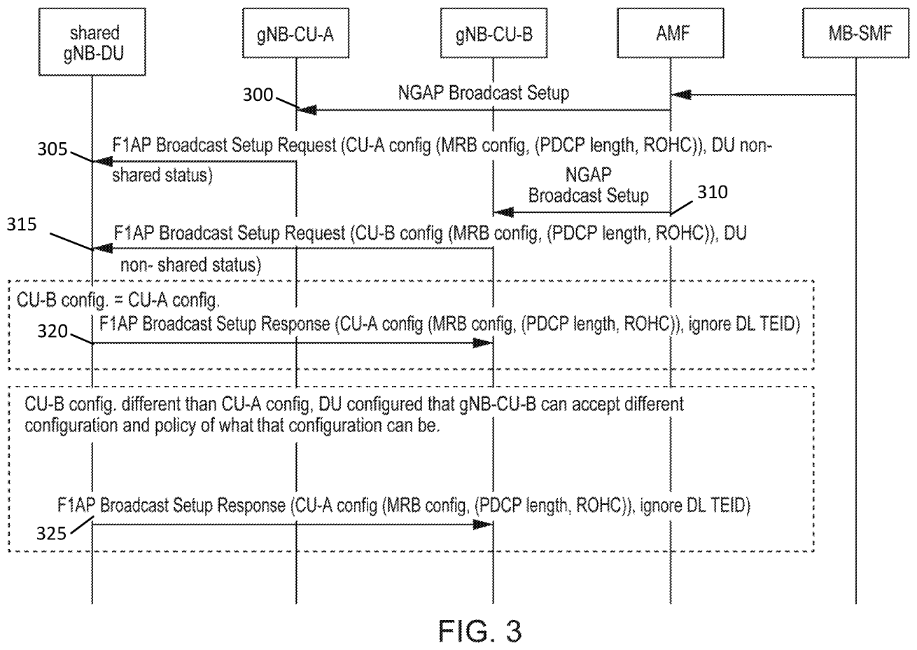

FIG. 3 illustrates an example signal flow diagram according to certain example embodiments. At 300, the application management function (AMF) may initiate a next generation application protocol (NGAP) broadcast setup to gNB-CU-A. At 305, the shared gNB-DU may receive an F1 broadcast setup request from gNB-CU-A. According to some example embodiments, the configuration of CU-A may include an MRB ID, PDCP SN-length, and ROHC. According to other example embodiments, the F1 broadcast setup request message may include a “DU non-shared status” parameter indicating whether the gNB-CU-A already provides the same MBS broadcast service to one or more other non-shared gNB-DUs. At 310, the AMF may initiate NGAP broadcast setup to gNB-CU-B.

At 315, the shared gNB-DU may receive an F1 broadcast setup request from gNB-CU-B with the MRB configuration of CU-B. The configuration of CU-B may include an MRB ID, PDCP SN-length, and ROHC. In some example embodiments, the F1 broadcast setup request message from gNB-CU-B may also include a “DU non-shared status” parameter indicating whether the gNB-CU-B already provides the service to one or more other non-shared DUs. At 320, shared gNB-DU may determine that the configuration of CU-B is same as that of the configuration of CU-A. As such, the shared gNB-DU may accept the F1 setup context and send back an F1 broadcast setup response message to gNB-CU-B. In other example embodiments, if the shared gNB-DU determines that the configuration of CU-B is not same as the configuration of CU-A, at 325, the shared gNB-DU sends gNB-CU's configuration to gNB-CU-B in an FIAP Broadcast Setup Response. In certain example embodiments, the shared gNB-DU may be configured to know that gNB-CU-B is ready to accept either any other running configuration from gNB-CU-A, or a configuration run by gNB-CU-A that fits a given policy.

According to certain example embodiments, in both operations 320 and 325, the shared gNB-DU may also include in the F1 broadcast setup response message, a new indication, “ignore DU DL TEID”, of whether the F1-U tunnel should be setup or not between the shared gNB-DU and the gNB-CU-B. Given that the DU DL TEID is currently mandatory in the response message, it may include an indicator indicating whether this DU DL TEID should be ignored (i.e., only the F1-U between the shared gNB-DU and gNB-CU-A will deliver the data) or not (i.e., the F1-U between the shared gNB-DU and gNB-CU-B is an additional setup for redundancy).

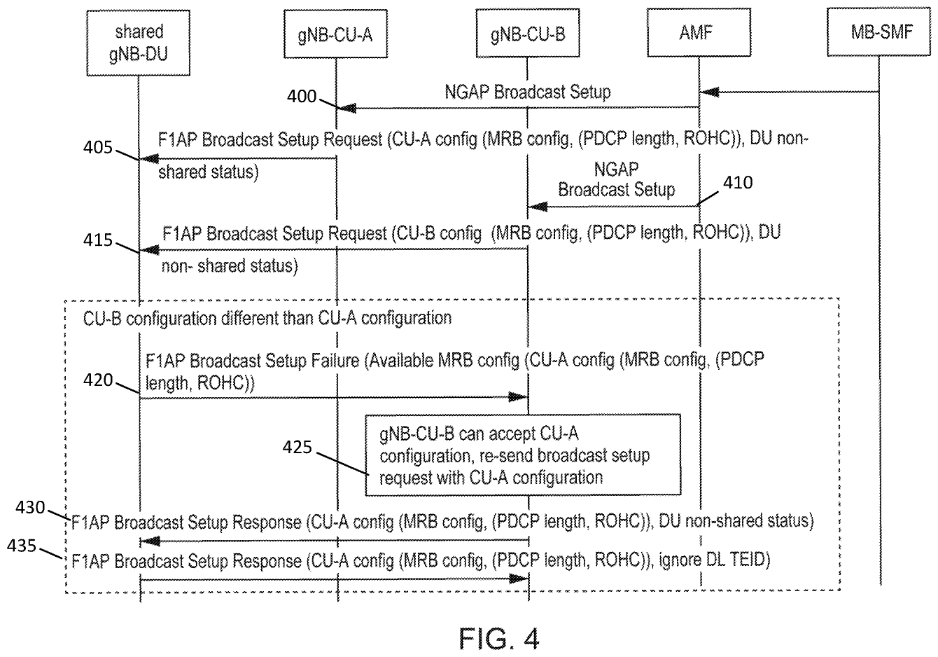

FIG. 4 illustrates another example signal flow diagram, according to certain example embodiments. As shown in FIG. 4, operations 400 to 415 may be similar to operations 300 to 315 in FIG. 3. At 420, the shared gNB-DU may determine that the configuration of CU-B is different from the configuration of CU-A and/or not compatible. Thus, at 420, the shared gNB-DU may transmit a F1 broadcast failure message which may include the available MRB configuration information element (IE), and the available MRB configuration IE may include the current operating CU-A configuration from gNB-CU-A. At 425, if gNB-CU-B can accept to operate according to the configuration of CU-A, gNB-CU-B may decide to send an F1 broadcast setup request message again including the CU-A configuration. In some example embodiments, the F1 broadcast setup request message may also include a “DU non-shared status” parameter indicating whether gNB-CU-B already provides the service to one or more other non-shared DUs.

At 430, the shared gNB-DU may receive from the gNB-CU-B a broadcast setup request containing MRB configuration that matches the current CU-A's configuration that it received from the shared gNB-DU. At 435, the shared gNB-DU may accept the F1 broadcast setup request, and transmit an F1 broadcast setup response message to gNB-CU-B. In some example embodiments, the F1 broadcast setup request message sent at 430 may include a “DU non-shared status” parameter indicating whether the gNB-CU-B already provides the service to one or more other non-shared DUs. Further, similar to the example embodiments described above with regard to FIG. 3, in some example embodiments, the shared gNB-DU may, at 435, include a new indicator “ignore DU DL TEID” to indicate whether an additional F1-U tunnel is to be used between the shared gNB-DU and the gNB-CU-B. Since DU DL TEID may be mandatory in the broadcast setup response message, DU DL TEID may include an indicator indicating whether DU DL TEID should be ignored (i.e., only the F1-U between the shared gNB-DU and gNB-CU-A will deliver the data), or not ignored (i.e., the F1-U between the shared gNB-DU and gNB-CU-B UP is an additional setup for redundancy).

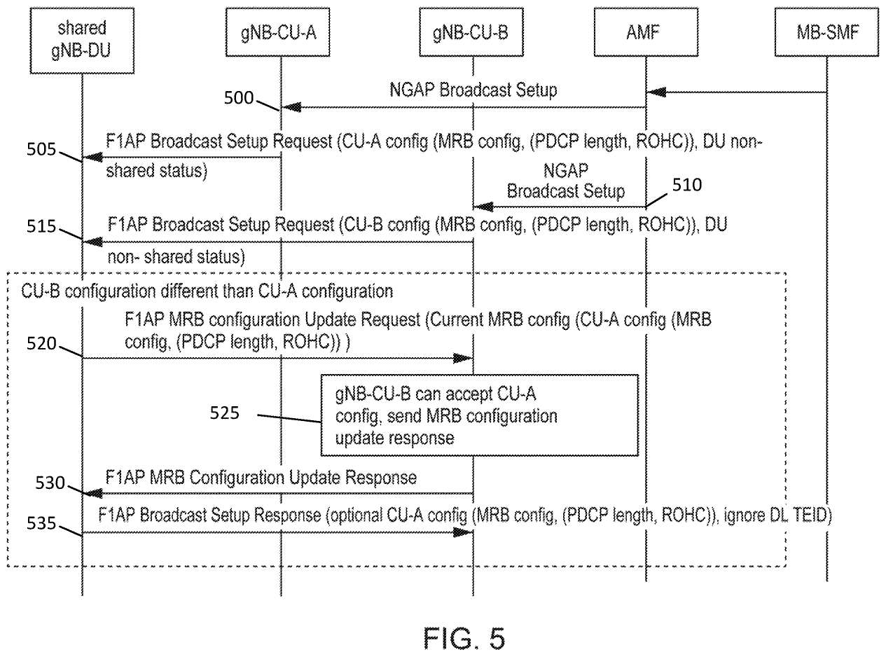

FIG. 5 illustrates another example signal flow diagram, according to certain example embodiments. As shown in FIG. 5, operations 500 to 515 may be similar to operations 300 to 315 in FIG. 3. At 520, the shared gNB-DU may determine that the configuration of CU-B is different from the configuration of CU-A, and/or not compatible. Thus, at 520, the shared gNB-DU may trigger a new MRB configuration update request procedure towards gNB-CU-B in the form of an FIAP MRB configuration update request message. In some example embodiments, the F1AP MRB configuration update request message may include the current operating CU-A configuration from gNB-CU-A.

At 525, gNB-CU-B may accept to operate according to the CU-A configuration, and may signal its acceptance to the shared gNB-DU by sending an F1 MRB configuration response message, at 530. At 535, upon receiving the F1 MRB configuration response message from gNB-CU-B, the shared gNB-DU may understand that gNB-CU-B accepts to operate according to the configuration of CU-A, and the shared gNB-DU may make the final reply to the gNB-CU-B using F1 broadcast setup response message (which includes the CU-A configuration). According to certain example embodiments, the F1 broadcast setup response message sent from the shared gNB-DU may include the CU-A configuration instead of the originally requested CU-B configuration. In some example embodiments, the inclusion of the CU-A configuration in the F1 broadcast setup response message at 535 may be optional. In other words, the gNB-CU-B may already consider that the received broadcast setup response corresponds to CU-A configuration based on the transmission of the response message at 530.

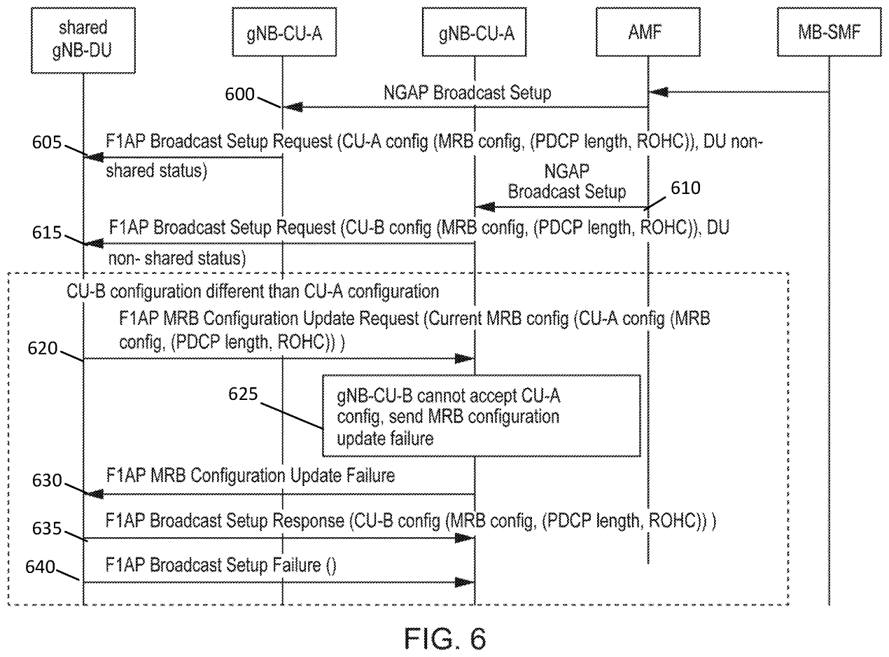

FIG. 6 illustrates another example signal flow diagram, according to certain example embodiments. As shown in FIG. 6, operations 600 to 615 may be similar to operations 300 to 315 in FIG. 3, and operation 620 may be similar to operation 520 in FIG. 5. At 625, gNB-CU-B may determine not to accept the shared gNB-DU's configuration proposal of the CU-A configuration. At 630, gNB-CU-B may respond to the shared gNB-DU by transmitting a rejection response message. At 635, the shared gNB-DU may determine to use both the configurations of CU-A and CU-B separately. By using both the configurations of CU-A and CU-B separately, multiple data transmissions may be performed by the shared gNB-DU. For example, as illustrated in FIG. 6, at 635, the shared gNB-DU may transmit a reply to gNB-CU-B with a broadcast setup response including the originally requested CU-B configuration. This means that the shared gNB-DU may operate such that the data may be broadcast two times for the two different TMGIs. Additionally, in certain example embodiments, the shared gNB-DU may add an additional indication that the broadcast may not be efficient as two different broadcast data transmissions may use separate radio resources, but this may be optional as the gNB-CU-B may understand this from operation 630.

Alternatively, in other example embodiments, the shared gNB-DU may, at 640, continue with a single configuration that can be transparent to gNB-CUs. For example, at 640, the shared gNB-DU may reply to the gNB-CU-B with the broadcast setup failure message to the originally requested CU-B configuration. This means that the shared gNB-DU may continue the broadcast with only the configuration of CU-A.

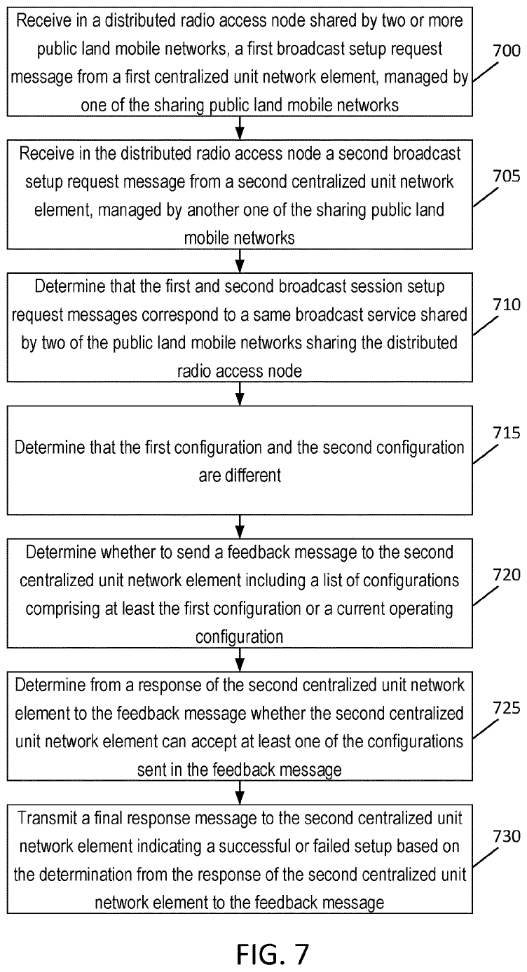

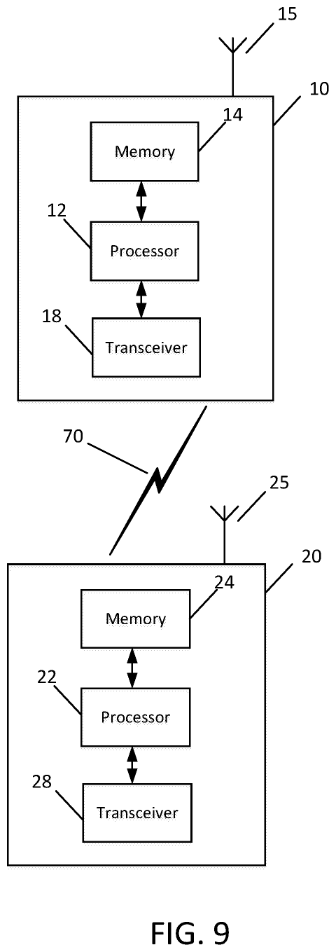

FIG. 7 illustrates an example of a flow diagram of a method, according to certain example embodiments. In an example embodiment, the method of FIG. 7 may be performed by a network entity, or a group of multiple network elements in a 3GPP system, such as LTE or 5G-NR. For instance, in an example embodiment, the method of FIG. 7 may be performed by a network, cell, gNB, gNB-DU, gNB-CU, or any other device similar to one of apparatuses 10 or 20 illustrated in FIG. 9.

According to certain example embodiments, the method of FIG. 7 may include, at 700, receiving in a distributed radio access node shared by two or more public land mobile networks, a first broadcast setup request message from a first centralized unit network element, managed by one of the sharing public land mobile networks. According to certain example embodiments, the first broadcast setup request message may include a first configuration of the first centralized unit network element. The method may also include, at 705, receiving in the distributed radio access node a second broadcast setup request message from a second centralized unit network element, managed by another one of the sharing public land mobile networks. According to certain example embodiments, the second broadcast setup request message includes a second configuration of the second centralized unit network element. The method may further include, at 710, determining that the first and second broadcast session setup request messages correspond to a same broadcast service shared by two of the public land mobile networks sharing the distributed radio access node. In addition, the method may include, at 715, determining that the first configuration and the second configuration are different. Further, the method may include, at 720, determining whether to send a feedback message to the second centralized unit network element including a list of configurations including at least the first configuration or a current operating configuration. The method may also include, at 725, determining from a response of the second centralized unit network element to the feedback message whether the second centralized unit network element can accept at least one of the configurations sent in the feedback message. The method may further include, at 730, transmitting a final response message to the second centralized unit network element indicating a successful or failed setup based on the determination from the response of the second centralized unit network element to the feedback message.

According to certain example embodiments, the feedback message to the second centralized unit network element may be a broadcast setup failure message including a list of available configurations proposed by the distributed radio access node including at least the current operating configuration or the first configuration. According to some example embodiments, the response to the feedback message may be a new broadcast setup request message sent by the second centralized unit network element including one configuration out of the list of available configurations proposed by the distributed radio access node including at least the current ongoing configuration or the first configuration, or another configuration proposed by the second centralized unit network element. According to other example embodiments, the feedback message may be a multicast radio bearer configuration update request message triggered by the distributed radio access node including a list of available configurations proposed by the distributed radio access node including at least the current operating configuration or the first configuration.

In certain example embodiments, the response to the feedback message may be either a multicast radio bearer configuration update successful response indicating that one of the available configurations can be accepted by the second centralized unit network element and which may include one or more of the accepted configurations, or may be a multicast radio bearer configuration failure unsuccessful message indicating that none of the available configurations proposed could be accepted by the second centralized unit network element and which may further include another configuration proposed by the second centralized unit network element. In some example embodiments, transmitting the final response message may include transmitting a broadcast setup response message to the second centralized unit network element if the configuration received from second centralized unit network element in the response to the feedback message is acceptable for the distributed radio access node. In other example embodiments, the final response message sent to the second centralized unit network element may include at least one of a current operating configuration of the first centralized unit network element, or any of the configurations that were included in the feedback message.

According to certain example embodiments, the distributed radio access node does not start an additional broadcast if the acceptable configuration received from the second centralized unit network element in the response to the feedback message corresponds to its current operating configuration. According to some example embodiments, the distributed radio access node does start additional broadcast if the acceptable configuration received from the second centralized unit network element in the response to the feedback message does not correspond to its current operating configuration. According to other example embodiments, transmitting the final response message including transmitting a broadcast setup failure message to the second centralized unit distributed unit if the configuration received from second centralized unit distributed unit in the response to the feedback message is not acceptable for the distributed radio access node.

In certain example embodiments, the broadcast setup response message may include an indication whether a user plane tunnel should be setup between the distributed radio access node and the second centralized unit network element. In other example embodiments, the first broadcast setup request message may include a first parameter indicating whether the first centralized network element provides the broadcast service to at least one non-shared distributed radio access nodes. In some example embodiments, the second broadcast setup request message may include a second parameter indicating whether the second centralized network element provides the broadcast service to at least one non-shared distributed radio access nodes. In further example embodiments, the indication whether a user plane tunnel should be setup between the distributed radio access node and the second centralized unit network element in the broadcast setup response message may be based on at least one of parameters received from the first and second centralized network elements indicating whether they provide a service to non-shared distributed radio access nodes, or a centralized network element from which the final configuration has been accepted.

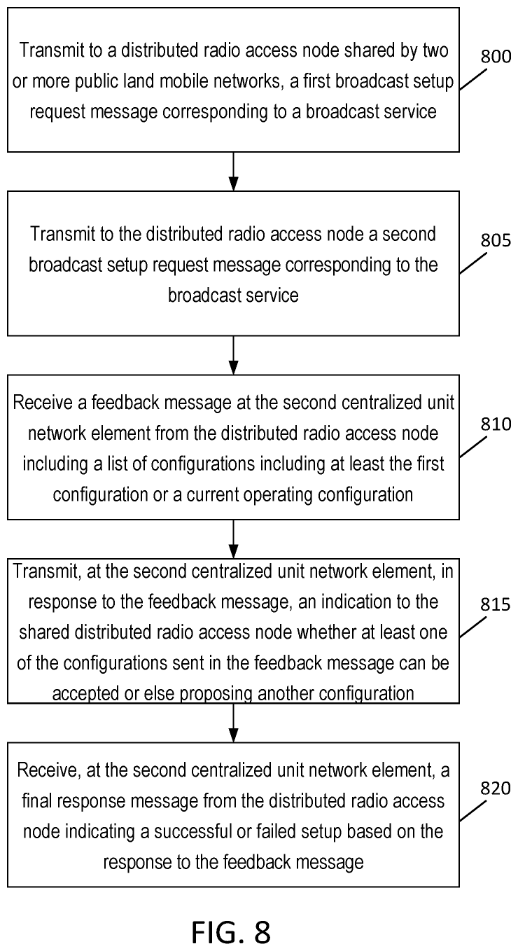

FIG. 8 illustrates an example of a flow diagram of another method, according to certain example embodiments. In an example embodiment, the method of FIG. 8 may be performed by a network entity, or a group of multiple network elements in a 3GPP system, such as LTE or 5G-NR. For instance, in an example embodiment, the method of FIG. 8 may be performed by a network, cell, gNB, gNB-DU, gNB-CU, or any other device similar to one of apparatuses 10 or 20 illustrated in FIG. 9.

According to certain example embodiments, the method of FIG. 8 may include, at 800, transmitting to a distributed radio access node shared by two or more public land mobile networks, a first broadcast setup request message corresponding to a broadcast service. According to certain example embodiments, the first broadcast setup request message may include a first configuration of a first centralized unit network element managed by one of the sharing public land mobile networks. The method may also include, at 805, transmitting to the distributed radio access node a second broadcast setup request message corresponding to the broadcast service. According to certain example embodiments, the second broadcast setup request message may include a second configuration of a second centralized unit network element managed by another one of the sharing public land mobile networks. The method may further include, at 810, receiving a feedback message at the second centralized unit network element from the distributed radio access node including a list of configurations including at least the first configuration or a current operating configuration. In addition, the method may include, at 815, transmitting, at the second centralized unit network element, in response to the feedback message, an indication to the distributed radio access node whether at least one of the configurations sent in the feedback message can be accepted or else proposing another configuration. Further, the method may include, at 820, receiving, at the second centralized unit network element, a final response message from the distributed radio access node indicating a successful or failed setup based on the response to the feedback message.

According to certain example embodiments, the feedback message may be a broadcast setup failure message including a list of available configurations proposed by the distributed radio access node including at least the current operating configuration or the first configuration. According to some example embodiments, the indication in response to the feedback message may include a new broadcast setup request message including one of the list of available configurations proposed by the distributed radio access node including at least the current ongoing configuration or the first configuration, or another configuration proposed by the second centralized unit network element. According to other example embodiments, the feedback message may be a multicast radio bearer configuration update request message triggered by the distributed radio access node including a list of available configurations proposed by the distributed radio access node including at least the current operating configuration or the first configuration.

In certain example embodiments, the indication in response to the feedback message may be either a multicast radio bearer configuration update successful indication indicating that one of the available configurations can be accepted by the second centralized unit network element and which may include one or more of the accepted configurations, or may be a multicast radio bearer configuration failure unsuccessful message indicating that none of the available configurations proposed could be accepted by the second centralized unit network element and which may include another configuration proposed by the second centralized unit network element. In some example embodiments, receiving the final response message may include receiving a broadcast setup response message at the second centralized unit network element if the transmitted configuration in the response to the feedback message is acceptable for the distributed radio access node. In other example embodiments, the final response message includes at least one of a current operating configuration of the first centralized unit network element, or any of the configurations that were included in the feedback message.

According to certain example embodiments, receiving the final response message may include receiving a broadcast setup failure message at the second centralized unit network element if the transmitted configuration in the response to the feedback message is not acceptable for the distributed radio access node. According to some example embodiments, the broadcast setup response message may include an indication whether a user plane tunnel should be setup between the distributed radio network node and the second centralized unit network element. According to other example embodiments, the first broadcast setup request message may include a first parameter indicating whether the first centralized network element provides the broadcast service to at least one non-shared distributed unit network elements.

In certain example embodiments, the second broadcast setup request message may include a second parameter indicating whether the second centralized network element provides the broadcast service to at least one non-shared distributed unit network elements. In some example embodiments, the indication whether a user plane tunnel should be setup between the distributed radio access node and the second centralized unit network element in the broadcast setup response message may be based on at least one of parameters received from the first and second centralized network elements indicating whether they provide the broadcast service to at least one non-shared distributed unit network elements, or a centralized network element from which the final configuration has been accepted.

FIG. 9 illustrates a set of apparatuses 10 and 20 according to certain example embodiments. In certain example embodiments, the apparatus 10 may be an element in a communications network or associated with such a network, such as a UE, mobile equipment (ME), mobile station, mobile device, stationary device, IoT device, or other device. It should be noted that one of ordinary skill in the art would understand that apparatus 10 may include components or features not shown in FIG. 9.

In some example embodiments, apparatus 10 may include one or more processors, one or more computer-readable storage medium (for example, memory, storage, or the like), one or more radio access components (for example, a modem, a transceiver, or the like), and/or a user interface. In some example embodiments, apparatus 10 may be configured to operate using one or more radio access technologies, such as GSM, LTE, LTE-A, NR, 5G, WLAN, WiFi, NB-IOT, Bluetooth, NFC, MulteFire, and/or any other radio access technologies. It should be noted that one of ordinary skill in the art would understand that apparatus 10 may include components or features not shown in FIG. 9.

As illustrated in the example of FIG. 9, apparatus 10 may include or be coupled to a processor 12 for processing information and executing instructions or operations. Processor 12 may be any type of general or specific purpose processor. In fact, processor 12 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 12 is shown in FIG. 9, multiple processors may be utilized according to other example embodiments. For example, it should be understood that, in certain example embodiments, apparatus 10 may include two or more processors that may form a multiprocessor system (e.g., in this case processor 12 may represent a multiprocessor) that may support multiprocessing. According to certain example embodiments, the multiprocessor system may be tightly coupled or loosely coupled (e.g., to form a computer cluster).

Processor 12 may perform functions associated with the operation of apparatus 10 including, as some examples, precoding of antenna gain/phase parameters, encoding and decoding of individual bits forming a communication message, formatting of information, and overall control of the apparatus 10, including processes and examples illustrated in FIGS. 3-8.

Apparatus 10 may further include or be coupled to a memory 14 (internal or external), which may be coupled to processor 12, for storing information and instructions that may be executed by processor 12. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 14 can be comprised of any combination of random access memory (RAM), read only memory (ROM), static storage such as a magnetic or optical disk, hard disk drive (HDD), or any other type of non-transitory machine or computer readable media. The instructions stored in memory 14 may include program instructions or computer program code that, when executed by processor 12, enable the apparatus 10 to perform tasks as described herein.

In certain example embodiments, apparatus 10 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 12 and/or apparatus 10 to perform any of the methods and examples illustrated in FIGS. 3-8.

In some example embodiments, apparatus 10 may also include or be coupled to one or more antennas 15 for receiving a downlink signal and for transmitting via an UL from apparatus 10. Apparatus 10 may further include a transceiver 18 configured to transmit and receive information. The transceiver 18 may also include a radio interface (e.g., a modem) coupled to the antenna 15. The radio interface may correspond to a plurality of radio access technologies including one or more of GSM, LTE, LTE-A, 5G, NR, WLAN, NB-IOT, Bluetooth, BT-LE, NFC, RFID, UWB, and the like. The radio interface may include other components, such as filters, converters (for example, digital-to-analog converters and the like), symbol demappers, signal shaping components, an Inverse Fast Fourier Transform (IFFT) module, and the like, to process symbols, such as OFDMA symbols, carried by a downlink or an UL.

For instance, transceiver 18 may be configured to modulate information on to a carrier waveform for transmission by the antenna(s) 15 and demodulate information received via the antenna(s) 15 for further processing by other elements of apparatus 10. In other example embodiments, transceiver 18 may be capable of transmitting and receiving signals or data directly. Additionally or alternatively, in some example embodiments, apparatus 10 may include an input and/or output device (I/O device). In certain example embodiments, apparatus 10 may further include a user interface, such as a graphical user interface or touchscreen.

In certain example embodiments, memory 14 stores software modules that provide functionality when executed by processor 12. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software. According to certain example embodiments, apparatus 10 may optionally be configured to communicate with apparatus 20 via a wireless or wired communications link 70 according to any radio access technology, such as NR.

According to certain example embodiments, processor 12 and memory 14 may be included in or may form a part of processing circuitry or control circuitry. In addition, in some example embodiments, transceiver 18 may be included in or may form a part of transceiving circuitry.

As illustrated in the example of FIG. 9, apparatus 20 may be a network, core network element, or element in a communications network or associated with such a network, such as a gNB, cell, or NW. It should be noted that one of ordinary skill in the art would understand that apparatus 20 may include components or features not shown in FIG. 9.

As illustrated in the example of FIG. 9, apparatus 20 may include a processor 22 for processing information and executing instructions or operations. Processor 22 may be any type of general or specific purpose processor. For example, processor 22 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 22 is shown in FIG. 9, multiple processors may be utilized according to other example embodiments. For example, it should be understood that, in certain example embodiments, apparatus 20 may include two or more processors that may form a multiprocessor system (e.g., in this case processor 22 may represent a multiprocessor) that may support multiprocessing. In certain example embodiments, the multiprocessor system may be tightly coupled or loosely coupled (e.g., to form a computer cluster).

According to certain example embodiments, processor 22 may perform functions associated with the operation of apparatus 20, which may include, for example, precoding of antenna gain/phase parameters, encoding and decoding of individual bits forming a communication message, formatting of information, and overall control of the apparatus 20, including processes and examples illustrated in FIGS. 3-8.

Apparatus 20 may further include or be coupled to a memory 24 (internal or external), which may be coupled to processor 22, for storing information and instructions that may be executed by processor 22. Memory 24 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 24 can be comprised of any combination of random access memory (RAM), read only memory (ROM), static storage such as a magnetic or optical disk, hard disk drive (HDD), or any other type of non-transitory machine or computer readable media. The instructions stored in memory 24 may include program instructions or computer program code that, when executed by processor 22, enable the apparatus 20 to perform tasks as described herein.

In certain example embodiments, apparatus 20 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 22 and/or apparatus 20 to perform the methods and examples illustrated in FIGS. 3-8.

In certain example embodiments, apparatus 20 may also include or be coupled to one or more antennas 25 for transmitting and receiving signals and/or data to and from apparatus 20. Apparatus 20 may further include or be coupled to a transceiver 28 configured to transmit and receive information. The transceiver 28 may include, for example, a plurality of radio interfaces that may be coupled to the antenna(s) 25. The radio interfaces may correspond to a plurality of radio access technologies including one or more of GSM, NB-IOT, LTE, 5G, WLAN, Bluetooth, BT-LE, NFC, radio frequency identifier (RFID), ultrawideband (UWB), MulteFire, and the like. The radio interface may include components, such as filters, converters (for example, digital-to-analog converters and the like), mappers, a Fast Fourier Transform (FFT) module, and the like, to generate symbols for a transmission via one or more downlinks and to receive symbols (for example, via an UL).

As such, transceiver 28 may be configured to modulate information on to a carrier waveform for transmission by the antenna(s) 25 and demodulate information received via the antenna(s) 25 for further processing by other elements of apparatus 20. In other example embodiments, transceiver 18 may be capable of transmitting and receiving signals or data directly. Additionally or alternatively, in some example embodiments, apparatus 20 may include an input and/or output device (I/O device).

In certain example embodiment, memory 24 may store software modules that provide functionality when executed by processor 22. The modules may include, for example, an operating system that provides operating system functionality for apparatus 20. The memory may also store one or more functional modules, such as an application or program, to provide additional functionality for apparatus 20. The components of apparatus 20 may be implemented in hardware, or as any suitable combination of hardware and software.

According to some example embodiments, processor 22 and memory 24 may be included in or may form a part of processing circuitry or control circuitry. In addition, in some example embodiments, transceiver 28 may be included in or may form a part of transceiving circuitry.

As used herein, the term “circuitry” may refer to hardware-only circuitry implementations (e.g., analog and/or digital circuitry), combinations of hardware circuits and software, combinations of analog and/or digital hardware circuits with software/firmware, any portions of hardware processor(s) with software (including digital signal processors) that work together to cause an apparatus (e.g., apparatus 10 and 20) to perform various functions, and/or hardware circuit(s) and/or processor(s), or portions thereof, that use software for operation but where the software may not be present when it is not needed for operation. As a further example, as used herein, the term “circuitry” may also cover an implementation of merely a hardware circuit or processor (or multiple processors), or portion of a hardware circuit or processor, and its accompanying software and/or firmware. The term circuitry may also cover, for example, a baseband integrated circuit in a server, cellular network node or device, or other computing or network device.

For instance, in certain example embodiments, apparatus 20 may be controlled by memory 24 and processor 22 to receive in a distributed radio access node shared by two or more public land mobile networks, a first broadcast setup request message from a first centralized unit network element, managed by one of the sharing public land mobile networks. According to certain example embodiments, the first broadcast setup request message may include a first configuration of the first centralized unit network element. Apparatus 20 may also be controlled by memory 24 and processor 22 to receive in the distributed radio access node a second broadcast setup request message from a second centralized unit network element, managed by another one of the sharing public land mobile networks. According to certain example embodiments, the second broadcast setup request message may include a second configuration of the second centralized unit network element. Apparatus 20 may further be controlled by memory 24 and processor 22 to determine that the first and second broadcast session setup request messages correspond to a same broadcast service shared by two of the public land mobile networks sharing the distributed radio access node. In addition, apparatus 20 may be controlled by memory 24 and processor 22 to determine that the first configuration and the second configuration are different. Further, apparatus 20 may be controlled by memory 24 and processor 22 to determine whether to send a feedback message to the second centralized unit network element including a list of configurations including at least the first configuration or a current operating configuration. Apparatus 20 may also be controlled by memory 24 and processor 22 to determine from a response of the second centralized unit network element to the feedback message whether the second centralized unit network element can accept at least one of the configurations sent in the feedback message. Apparatus 20 may further be controlled by memory 24 and processor 22 to transmit a final response message to the second centralized unit network element indicating a successful or failed setup based on the determination from the response of the second centralized unit network element to the feedback message.

In other example embodiments, apparatus 20 may be controlled by memory 24 and processor 22 to transmit to a distributed radio access node shared by two or more public land mobile networks, a first broadcast setup request message corresponding to a broadcast service. According to certain example embodiments, the first broadcast setup request message may include a first configuration of a first centralized unit network element managed by one of the sharing public land mobile networks. Apparatus 20 may also be controlled by memory 24 and processor 22 to transmit to the distributed radio access node a second broadcast setup request message corresponding to the broadcast service. According to certain example embodiments the second broadcast setup request message may include a second configuration of a second centralized unit network element managed by another one of the sharing public land mobile networks. Apparatus 20 may further be controlled by memory 24 and processor 22 to receive a feedback message at the second centralized unit network element from the distributed radio access node including a list of configurations including at least the first configuration or a current operating configuration. In addition, apparatus 20 may be controlled by memory 24 and processor 22 to transmit, at the second centralized unit network element, in response to the feedback message, an indication to the distributed radio access node whether at least one of the configurations sent in the feedback message can be accepted or else proposing another configuration. Further, apparatus 20 may be controlled by memory 24 and processor 22 to receive, at the second centralized unit network element, a final response message from the distributed radio access node indicating a successful or failed setup based on the response to the feedback message.

In some example embodiments, an apparatus (e.g., apparatus 10 and/or apparatus 20) may include means for performing a method, a process, or any of the variants discussed herein. Examples of the means may include one or more processors, memory, controllers, transmitters, receivers, and/or computer program code for causing the performance of the operations.

Certain example embodiments may also be directed to an apparatus that includes means for receiving in a distributed radio access node shared by two or more public land mobile networks, a first broadcast setup request message from a first centralized unit network element, managed by one of the sharing public land mobile networks. According to certain example embodiments, the first broadcast setup request message may include a first configuration of the first centralized unit network element. The apparatus may also include means for receiving in the distributed radio access node a second broadcast setup request message from a second centralized unit network element, managed by another one of the sharing public land mobile networks. According to certain example embodiments, the second broadcast setup request message includes a second configuration of the second centralized unit network element. The apparatus may further include means for determining that the first and second broadcast session setup request messages correspond to a same broadcast service shared by two of the public land mobile networks sharing the distributed radio access node. In addition, the apparatus may include means for determining that the first configuration and the second configuration are different. Further, the apparatus may include means for determining whether to send a feedback message to the second centralized unit network element including a list of configurations including at least the first configuration or a current operating configuration. The apparatus may also include means for determining from a response of the second centralized unit network element to the feedback message whether the second centralized unit network element can accept at least one of the configurations sent in the feedback message. The apparatus may further include means for transmitting a final response message to the second centralized unit network element indicating a successful or failed setup based on the determination from the response of the second centralized unit network element to the feedback message.

Certain example embodiments may also be directed to an apparatus that includes means for transmitting to a distributed radio access node shared by two or more public land mobile networks, a first broadcast setup request message corresponding to a broadcast service. According to certain example embodiments, the first broadcast setup request message may include a first configuration of a first centralized unit network element managed by one of the sharing public land mobile networks. The apparatus may also include means for transmitting to the distributed radio access node a second broadcast setup request message corresponding to the broadcast service. According to certain example embodiments, the second broadcast setup request message may include a second configuration of a second centralized unit network element managed by another one of the sharing public land mobile networks. The apparatus may further include means for receiving a feedback message at the second centralized unit network element from the distributed radio access node comprising a list of configurations comprising at least the first configuration or a current operating configuration. In addition, the apparatus may include means for transmitting, at the second centralized unit network element, in response to the feedback message, an indication to the distributed radio access node whether at least one of the configurations sent in the feedback message can be accepted or else proposing another configuration. In addition, the apparatus may include means for receiving, at the second centralized unit network element, a final response message from the distributed radio access node indicating a successful or failed setup based on the response to the feedback message.

Certain example embodiments described herein provide several technical improvements, enhancements, and/or advantages in terms of avoiding to have multiple configurations and hence multiple broadcasting (multiple radio resource usage) of the same data. For instance, in some example embodiments, it may be possible to provide means between a shared gNB-DU and non-shared gNB-CUs so that the desired MBS RAN sharing feature may be applied to such a deployment scenario.

A computer program product may include one or more computer-executable components which, when the program is run, are configured to carry out some example embodiments. The one or more computer-executable components may be at least one software code or portions of it. Modifications and configurations required for implementing functionality of certain example embodiments may be performed as routine(s), which may be implemented as added or updated software routine(s). Software routine(s) may be downloaded into the apparatus.

As an example, software or a computer program code or portions of it may be in a source code form, object code form, or in some intermediate form, and it may be stored in some sort of carrier, distribution medium, or computer readable medium, which may be any entity or device capable of carrying the program. Such carriers may include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers. The computer readable medium or computer readable storage medium may be a non-transitory medium.

In other example embodiments, the functionality may be performed by hardware or circuitry included in an apparatus (e.g., apparatus 10 or apparatus 20), for example through the use of an application specific integrated circuit (ASIC), a programmable gate array (PGA), a field programmable gate array (FPGA), or any other combination of hardware and software. In yet another example embodiment, the functionality may be implemented as a signal, a non-tangible means that can be carried by an electromagnetic signal downloaded from the Internet or other network.

According to certain example embodiments, an apparatus, such as a node, device, or a corresponding component, may be configured as circuitry, a computer or a microprocessor, such as single-chip computer element, or as a chipset, including at least a memory for providing storage capacity used for arithmetic operation and an operation processor for executing the arithmetic operation.

One having ordinary skill in the art will readily understand that the disclosure as discussed above may be practiced with procedures in a different order, and/or with hardware elements in configurations which are different than those which are disclosed. Therefore, although the disclosure has been described based upon these example embodiments, it would be apparent to those of skill in the art that certain modifications, variations, and alternative constructions would be apparent, while remaining within the spirit and scope of example embodiments. Although the above embodiments refer to 5G NR and LTE technology, the above embodiments may also apply to any other present or future 3GPP technology, such as LTE-advanced, and/or fourth generation (4G) technology.

### Partial Glossary

3GPP 3rd Generation Partnership Project
5G 5th Generation
5GCN 5G Core Network
5GS 5G System
BS Base Station
CHO Conditional Handover
eNB Enhanced Node B
E-UTRAN Evolved UTRAN
gNB 5G or Next Generation NodeB
LTE Long Term Evolution
NR New Radio
NTN Non-Terrestrial Network
NW Network
RACH Random Access Channel Procedure
RE Resource element
RRC Radio Resource Control
SSB Synchronization Signal Block
UE User Equipment
UL Uplink
UPF User Plane Function

1-52. (canceled)

53. An apparatus comprising:
at least one processor; and
at least one memory comprising computer program code,
the at least one memory and the computer program code configured to, with storing instructions that, when executed by the at least one processor, cause the apparatus at least to:
receive in the apparatus which is a distributed radio access node shared by two or more public land mobile networks, a first broadcast setup request message from a first centralized unit network element, managed by one of the sharing public land mobile networks, wherein the first broadcast setup request message comprises a first configuration of the first centralized unit network element;
receive in the apparatus a second broadcast setup request message from a second centralized unit network element, managed by another one of the sharing public land mobile networks, wherein the second broadcast setup request message comprises a second configuration of the second centralized unit network element;
determine that the first and second broadcast session setup request messages correspond to a same broadcast service shared by two of the public land mobile networks sharing the apparatus;
determine that the first configuration and the second configuration are different;
determine whether to send a feedback message to the second centralized unit network element including a list of configurations comprising at least the first configuration or a current operating configuration;
determine from a response of the second centralized unit network element to the feedback message whether the second centralized unit network element can accept at least one of the configurations sent in the feedback message; and
transmit a final response message to the second centralized unit network element indicating a successful or failed setup based on the determination from the response of the second centralized unit network element to the feedback message.

54. The apparatus of claim 53, wherein the feedback message to the second centralized unit network element is a broadcast setup failure message including a list of available configurations proposed by the apparatus comprising at least the current operating configuration or the first configuration.

55. The apparatus of claim 53, wherein the response to the feedback message is a new broadcast setup request message sent by the second centralized unit network element including one configuration out of the list of available configurations proposed by the apparatus comprising at least the current ongoing configuration or the first configuration, or another configuration proposed by the second centralized unit network element.

56. The apparatus of claim 53, wherein the feedback message is a multicast radio bearer configuration update request message triggered by the apparatus including a list of available configurations proposed by the apparatus comprising at least the current operating configuration or the first configuration.

57. The apparatus of claim 53, wherein the response to the feedback message is either a multicast radio bearer configuration update successful response indicating that one of the available configurations can be accepted by the second centralized unit network element and which may include one or more of the accepted configurations, or is a multicast radio bearer configuration failure unsuccessful message indicating that none of the available configurations proposed could be accepted by the second centralized unit network element and which may further include another configuration proposed by the second centralized unit network element.

58. The apparatus of claim 53, wherein transmitting the final response message comprises transmitting a broadcast setup response message to the second centralized unit network element if the configuration received from second centralized unit network element in the response to the feedback message is acceptable for the apparatus.

59. The apparatus of claim 58, wherein the final response message sent to the second centralized unit network element comprises at least one of the following:
a current operating configuration of the first centralized unit network element, or
any of the configurations that were included in the feedback message.

60. The apparatus of claim 58,
wherein the apparatus does not start an additional broadcast if the acceptable configuration received from the second centralized unit network element in the response to the feedback message corresponds to its current operating configuration, and
wherein the apparatus does start additional broadcast if the acceptable configuration received from the second centralized unit network element in the response to the feedback message does not correspond to its current operating configuration.

61. The apparatus of claim 53, wherein transmitting the final response message comprises transmitting a broadcast setup failure message to the second centralized unit distributed unit if the configuration received from second centralized unit distributed unit in the response to the feedback message is not acceptable for the apparatus.

62. The apparatus of claim 53, wherein the broadcast setup response message comprises an indication whether a user plane tunnel should be setup between the apparatus and the second centralized unit network element.

63. The apparatus of claim 53, wherein the first broadcast setup request message comprises a first parameter indicating whether the first centralized network element provides the broadcast service to at least one non-shared distributed radio access nodes.

64. The apparatus of claim 53, wherein the second broadcast setup request message comprises a second parameter indicating whether the second centralized network element provides the broadcast service to at least one non-shared distributed radio access nodes.

65. The apparatus of claim 53, wherein the indication whether a user plane tunnel should be setup between the apparatus and the second centralized unit network element in the broadcast setup response message is based on at least one of the following:
parameters received from the first and second centralized network elements indicating whether they provide a service to non-shared distributed radio access nodes, or
a centralized network element from which the final configuration has been accepted.

66. An apparatus, comprising:
at least one processor; and
at least one memory comprising computer program code,
the at least one memory and the computer program code configured to, with storing instructions that, when executed by the at least one processor, cause the apparatus at least to:
transmit to a distributed radio access node shared by two or more public land mobile networks, a first broadcast setup request message corresponding to a broadcast service, wherein the first broadcast setup request message comprises a first configuration of a first centralized unit network element managed by one of the sharing public land mobile networks;
transmit to the distributed radio access node a second broadcast setup request message corresponding to the broadcast service, wherein the second broadcast setup request message comprises a second configuration of a second centralized unit network element managed by another one of the sharing public land mobile networks;
receive a feedback message at the second centralized unit network element from the distributed radio access node comprising a list of configurations comprising at least the first configuration or a current operating configuration;
transmit, at the second centralized unit network element, in response to the feedback message, an indication to the distributed radio access node whether at least one of the configurations sent in the feedback message can be accepted or else proposing another configuration; and
receive, at the second centralized unit network element, a final response message from the distributed radio access node indicating a successful or failed setup based on the response to the feedback message.

67. The apparatus of claim 66, wherein the feedback message is a broadcast setup failure message including a list of available configurations proposed by the distributed radio access node comprising at least the current operating configuration or the first configuration.

68. The apparatus of claim 66, wherein the indication in response to the feedback message comprises a new broadcast setup request message including one of the list of available configurations proposed by the distributed radio access node comprising at least the current ongoing configuration or the first configuration, or another configuration proposed by the second centralized unit network element.

69. The apparatus of claim 66, wherein the feedback message is a multicast radio bearer configuration update request message triggered by the distributed radio access node including a list of available configurations proposed by the distributed radio access node comprising at least the current operating configuration or the first configuration.

70. The apparatus of claim 66, wherein the indication in response to the feedback message is either a multicast radio bearer configuration update successful indication indicating that one of the available configurations can be accepted by the second centralized unit network element and which may include one or more of the accepted configurations, or is a multicast radio bearer configuration failure unsuccessful message indicating that none of the available configurations proposed could be accepted by the second centralized unit network element and which may include another configuration proposed by the second centralized unit network element.

71. The apparatus of claim 66, wherein receiving the final response message comprises receiving a broadcast setup response message at the second centralized unit network element if the transmitted configuration in the response to the feedback message is acceptable for the distributed radio access node.

72. A method comprising:
receiving in a distributed radio access node shared by two or more public land mobile networks, a first broadcast setup request message from a first centralized unit network element, managed by one of the sharing public land mobile networks, wherein the first broadcast setup request message comprises a first configuration of the first centralized unit network element;
receiving in the distributed radio access node a second broadcast setup request message from a second centralized unit network element, managed by another one of the sharing public land mobile networks, wherein the second broadcast setup request message comprises a second configuration of the second centralized unit network element;
determining that the first and second broadcast session setup request messages correspond to a same broadcast service shared by two of the public land mobile networks sharing the distributed radio access node;
determining that the first configuration and the second configuration are different;
determining whether to send a feedback message to the second centralized unit network element including a list of configurations comprising at least the first configuration or a current operating configuration;
determining from a response of the second centralized unit network element to the feedback message whether the second centralized unit network element can accept at least one of the configurations sent in the feedback message; and
transmitting a final response message to the second centralized unit network element indicating a successful or failed setup based on the determination from the response of the second centralized unit network element to the feedback message.
